(19) United States
(12) Patent Application Publication
(10) Pub. No.: US 2024/0354161 A1
(43) Pub. Date: Oct. 24, 2024

(54) NATURAL LANGUAGE PROCESSING SYSTEM WITH MACHINE LEARNING FOR ALLOCATION OF INFORMATION TECHNOLOGY RESOURCES

(71) Applicant: Dell Products L.P., Round Rock, TX (US)

(72) Inventors: Dhilip S. Kumar, Bangalore (IN); Narendra Thota, Clarksburg, MD (US); Ajay Maikhuri, Bangalore (IN); Robert A. Lincourt, JR., Franklin, MA (US)

(21) Appl. No.: 18/137,819

(22) Filed: Apr. 21, 2023

(51) Int. Cl. G06F 9/50; G06F 40/205

(52) U.S. Cl. CPC G06F 9/5027; G06F 40/205

(57) ABSTRACT

An apparatus comprises a processing device configured to perform natural language processing of a first set of documents to generate a first data structure and a second set of documents to generate a second data structure, the first set of documents characterizing information associated with a user of an organization and the second set of documents characterizing information associated with the organization. The processing device is further configured to process the first data structure and the second data structure utilizing one or more machine learning models to generate a third data structure characterizing resources of an information technology infrastructure to be allocated for use by the user of the organization, and to generate one or more control signals for allocating one or more resources of the information technology infrastructure for use by the user of the organization based at least in part on the third data structure.

### FIELD

The field relates generally to information processing, and more particularly to techniques for use in machine learning-based data processing.

### BACKGROUND

As the value and use of information continues to increase, individuals and businesses seek additional ways to process and store information. Information handling systems and other types of information processing systems may be used to process, compile, store and communicate various types of information. Because technology and information handling needs and requirements vary between different users or applications, information handling systems may also vary (e.g., in what information is handled, how the information is handled, how much information is processed, stored, or communicated, how quickly and efficiently the information may be processed, stored, or communicated, etc.). Information handling systems may be configured as general purpose, or as special purpose configured for one or more specific users or use cases (e.g., financial transaction processing, airline reservations, enterprise data storage, global communications, etc.). Information handling systems may include a variety of hardware and software components that may be configured to process, store, and communicate information and may include one or more computer systems, data storage systems, and networking systems.

### SUMMARY

Illustrative embodiments of the present disclosure provide techniques for natural language processing with machine learning for allocation of information technology resources.

In one embodiment, an apparatus comprises at least one processing device comprising a processor coupled to a memory. The at least one processing device is configured to perform natural language processing of a first set of documents to generate a first data structure, the first set of documents characterizing information associated with a user of an organization. The at least one processing device is also configured to perform natural language processing of a second set of documents to generate a second data structure, the second set of documents characterizing information associated with the organization. The at least one processing device is further configured to process the first data structure and the second data structure utilizing one or more machine learning models to generate a third data structure, the third data structure characterizing resources of an information technology infrastructure to be allocated for use by the user of the organization. The at least one processing device is further configured to generate one or more control signals for allocating one or more resources of the information technology infrastructure for use by the user of the organization based at least in part on the third data structure.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for generation of individual development plans based on skill gaps identified between user-accrued skills and organization role-based skills in an illustrative embodiment.

FIG. 2 is a flow diagram of an exemplary process for generation of individual development plans based on skill gaps identified between user-accrued skills and organization role-based skills in an illustrative embodiment.

FIG. 3 shows operation of an intuitive systematic individual development plan engine tool in an illustrative embodiment.

FIG. 4 shows a system implementing an intuitive systematic individual development plan engine in an illustrative embodiment.

FIG. 5 shows tables illustrating examples of a skill assessment corpus and a goal-skill corpus in an illustrative embodiment.

FIG. 6 shows a target dependent long short-term memory network architecture for performing sentiment analysis in an illustrative embodiment.

FIG. 7 shows a table of examples and observations derived from a self-assessment document in an illustrative embodiment.

FIG. 8 shows a table of examples and observations derived from a year-end assessment document in an illustrative embodiment.

FIG. 9 shows tables illustrating required skills determined from strategic goals, accrued skills determined from assessment documents, and skill gaps determined therefrom in an illustrative embodiment.

FIG. 10 shows a skill repository implementing a skill labeling and indexing database in an illustrative embodiment.

FIG. 11 shows a table of information stored in a skill repository in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

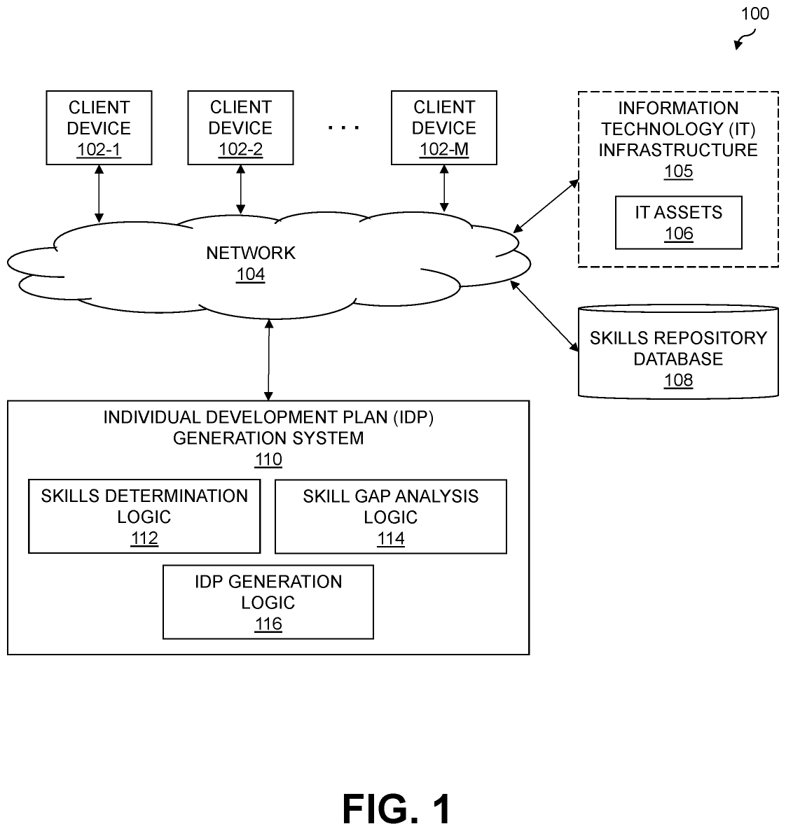

FIG. 1 shows an information processing system 100 configured in accordance with an illustrative embodiment. The information processing system 100 is assumed to be built on at least one processing platform and provides functionality for generation of individual development plans (IDPs) based on skill gaps identified between user-accrued skills and organization role-based skills. The information processing system 100 includes a set of client devices 102-1, 102-2, . . . 102-M (collectively, client devices 102) which are coupled to a network 104. Also coupled to the network 104 is an information technology (IT) infrastructure 105 comprising one or more IT assets 106, a skills repository database 108, and an individual development plan (IDP) generation system 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the IDP generation system 110 is used for an enterprise system. For example, an enterprise may subscribe to or otherwise utilize the IDP generation system 110 for generating individual development plans (IDPs) for users of the enterprise system, and for allocating resources of the IT infrastructure 105 for use in developing needed and optional skills specified in the generated IDPs. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different business, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The skills repository database 108 is configured to store and record various information that is utilized by the IDP generation system 110 for generating and implementing IDPs (e.g., for users of an enterprise system). The skills repository database 108, for example, may store information on different skills, courses and documents used for generating and implementing the IDPs. In some embodiments, one or more of the storage systems utilized to implement the skills repository database 108 comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the IDP generation system 110, as well as to support communication between the IDP generation system 110 and other related systems and devices not explicitly shown.

The client devices 102 are configured to access or otherwise utilize the IT infrastructure 105. In some embodiments, the client devices 102 are assumed to be associated with system administrators, IT managers or other authorized personnel responsible for managing the IT assets 106 of the IT infrastructure 105. For example, a given one of the client devices 102 may be operated by a user to access a graphical user interface (GUI) provided by the IDP generation system 110 to generate IDPs for users of an enterprise system or other organization or entity, and for selecting IT assets 106 of the IT infrastructure 105 which may be used to provide resources for developing needed and optional skills set forth in the generated IDPs. The IDP generation system 110 may be provided as a cloud service. In some embodiments, the IT assets 106 of the IT infrastructure 105 are owned or operated by the same enterprise that operates the IDP generation system 110. In other embodiments, the IT assets 106 of the IT infrastructure 105 may be owned or operated by one or more enterprises different than the enterprise which operates the IDP generation system 110. Various other examples are possible.

In some embodiments, the client devices 102 and/or the IT assets 106 of the IT infrastructure 105 may implement host agents that are configured for automated transmission of information which are utilized in generating and implementing IDPs. It should be noted that a “host agent” as this term is generally used herein may comprise an automated entity, such as a software entity running on a processing device. Accordingly, a host agent need not be a human entity.

The IDP generation system 110 in the FIG. 1 embodiment is assumed to be implemented using at least one processing device. Each such processing device generally comprises at least one processor and an associated memory, and implements one or more functional modules or logic for controlling certain features of the IDP generation system 110. In the FIG. 1 embodiment, the IDP generation system 110 implements skills determination logic 112, skill gap analysis logic 114, and IDP generation logic 116. The skills determination logic 112 is configured to determine, for a particular user or other entity, a set of accrued skills as well a set of required skills for the role of that user or other entity within a particular organization. The skill gap analysis logic 114 is configured to determine gaps between the set of accrued skills and the set of required skills, in order to identify which skills are to be developed for that user. The IDP generation logic 116 is configured to generate personalized IDPs for different users based on the identified skills which are to be developed for such users.

It is to be appreciated that the particular arrangement of the client devices 102, the IT infrastructure 105, the skills repository database 108 and the IDP generation system 110 illustrated in the FIG. 1 embodiment is presented by way of example only, and alternative arrangements can be used in other embodiments. As discussed above, for example, the IDP generation system 110 (or portions of components thereof, such as one or more of the skills determination logic 112, the skill gap analysis logic 114 and the IDP generation logic 116) may in some embodiments be implemented internal to one or more of the client devices 102 and/or the IT infrastructure 105.

At least portions of the skills determination logic 112, the skill gap analysis logic 114 and the IDP generation logic 116 may be implemented at least in part in the form of software that is stored in memory and executed by a processor.

The IDP generation system 110 and other portions of the information processing system 100, as will be described in further detail below, may be part of cloud infrastructure.

The IDP generation system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the skills repository database 108 and the IDP generation system 110 or components thereof (e.g., the skills determination logic 112, the skill gap analysis logic 114 and the IDP generation logic 116) may be implemented on respective distinct processing platforms, although numerous other arrangements are possible. For example, in some embodiments at least portions of the IDP generation system 110 and one or more of the client devices 102, the IT infrastructure 105 and/or the skills repository database 108 are implemented on the same processing platform. A given client device (e.g., 102-1) can therefore be implemented at least in part within at least one processing platform that implements at least a portion of the IDP generation system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the skills repository database 108 and the IDP generation system 110, or portions or components thereof, to reside in different data centers. Numerous other distributed implementations are possible. The IDP generation system 110 can also be implemented in a distributed manner across multiple data centers.

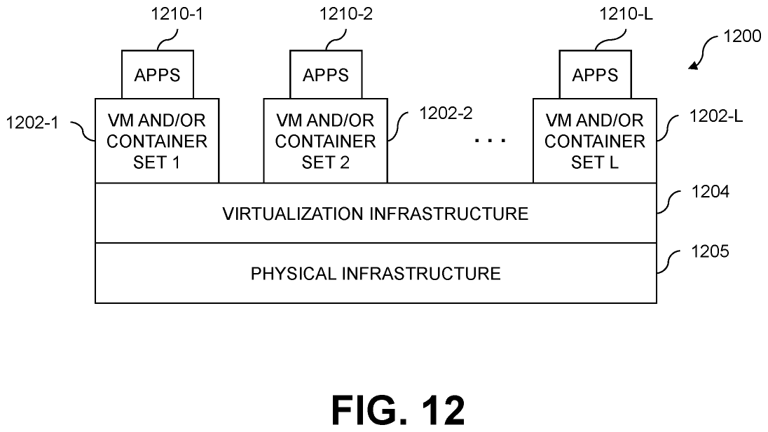

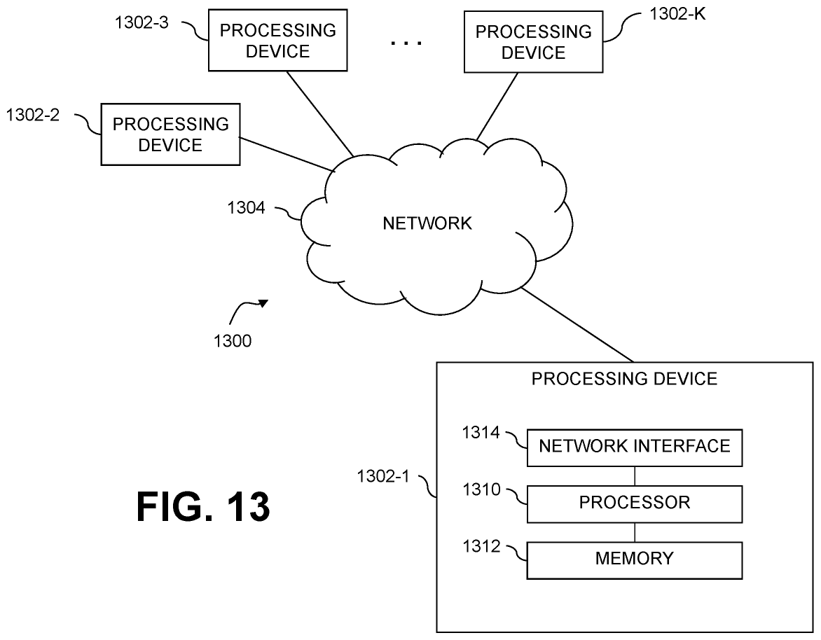

Additional examples of processing platforms utilized to implement the IDP generation system 110 and other components of the information processing system 100 in illustrative embodiments will be described in more detail below in conjunction with FIGS. 12 and 13.

It is to be appreciated that these and other features of illustrative embodiments are presented by way of example only, and should not be construed as limiting in any way.

It is to be understood that the particular set of elements shown in FIG. 1 for generation of IDPs based on skill gaps identified between user-accrued skills and organization role-based skills is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

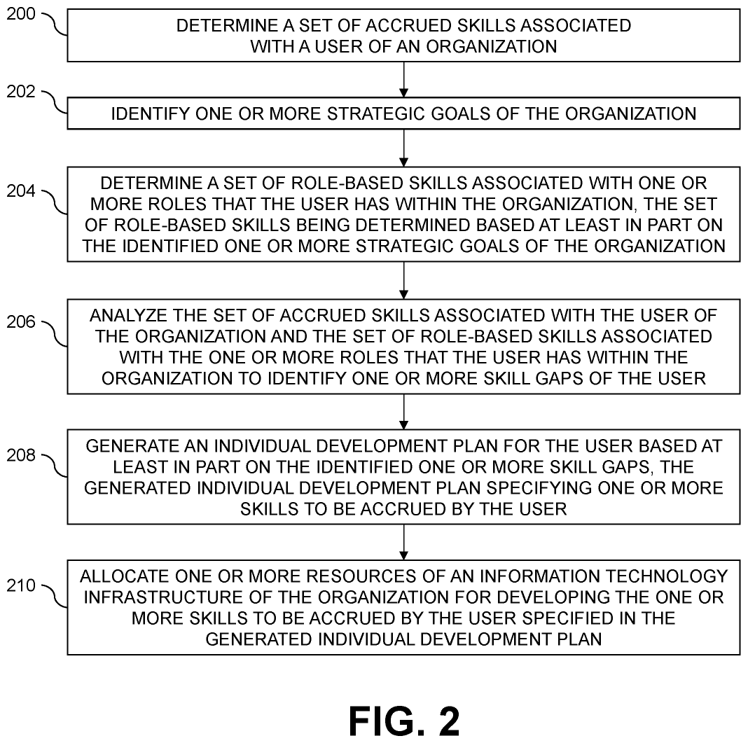

An exemplary process for generation of IDPs based on skill gaps identified between user-accrued skills and organization role-based skills will now be described in more detail with reference to the flow diagram of FIG. 2. It is to be understood that this particular process is only an example, and that additional or alternative processes for generation of IDPs based on skill gaps identified between user-accrued skills and organization role-based skills may be used in other embodiments.

In this embodiment, the process includes steps 200 through 210. These steps are assumed to be performed by the IDP generation system 110 utilizing the skills determination logic 112, the skill gap analysis logic 114 and the IDP generation logic 116. The process begins with step 200, determining a set of accrued skills associated with a user of an organization. Step 200 may include performing natural language processing (NLP) of one or more text documents associated with the user of the organization. The one or more text documents associated with the user of the organization may comprise at least one of a user self-assessment document, a periodic assessment document generated by a manager of the user in the organization, a talent profile of the user, etc. The NLP may utilize target-dependent sentiment classification of content of the one or more text documents.

In step 202, one or more strategic goals of the organization are identified. A set of role-based skills associated with one or more roles that the user has within the organization are determined in step 204. The set of role-based skills are determined based at least in part on the identified one or more strategic goals of the organization. Steps 200, 202 and 204 may comprise utilizing a Recurrent Neural Network (RNN) machine learning model that performs NLP of content of one or more documents. The RNN machine learning model may comprise one or more Target Dependent Long Short-Term Memory (TD-LSTM) networks. The set of role-based skills associated with the one or more roles that the user has within the organization may comprise one or more career-related skills, one or more productivity-related skills, one or more project-related skills associated with one or more projects that the user is performing for the organization, etc. The set of role-based skills associated with the one or more roles that the user has within the organization comprises at least one of cloud computing, machine learning, communication, digitization, software development lifecycle processes, mainframe and cryptography.

The FIG. 2 process continues with step 206, analyzing the set of accrued skills associated with the user of the organization and the set of role-based skills associated with the one or more roles that the user has within the organization to identify one or more skill gaps of the user. In step 208, an IDP is generated for the user based at least in part on the identified one or more skill gaps. The generated IDP specifies one or more skills to be accrued by the user. One or more resources of an IT infrastructure of the organization are allocated in step 210 for developing the one or more skills to be accrued by the user specified in the generated IDP. The one or more skills to be accrued by the user specified in the generated IDP may comprise a first set of one or more required skills and a second set of one or more optional skills, the first set of one or more required skills being determined based at least in part on the one or more roles that the user has within the organization, the second set of one or more optional skills being determined based at least in part on one or more assessment documents associated with the user. Step 210 may comprise conditioning selection of one or more courses for developing at least a given one of the one or more skills to be accrued by the user based at least in part on preferences related to sources of the one or more courses. In some cases, step 210 includes provisioning one or more workspaces (e.g., analytic sandboxes) with IT resources (e.g., processing, memory, storage, networking, etc.) being assigned to such workspaces based on the skills to be developed as specified in a generated IDP. Such provisioning may further include loading software or applications in the workspaces, with such software or applications being used to deliver courses, training, etc. for developing the skills specified in the generated IDP.

An individual development plan or IDP is a customized agreement between a first entity and a second entity that details new skills to be acquired or learned by the second entity. In various embodiments described below, it is assumed that the first entity is an employer and the second entity is an employee. It should be appreciated, however, that the first and second entities are not limited to employers and employees. An IDP may be a customized agreement, for example, between an educational organization and a student, between a team (e.g., a sports team) and a player or member of the team, between a first company or organization and a second company or organization that do business with one another, etc. Various other examples are possible. IDPs are one of the tools that employers (or other entities) have at their disposal to assist employees (or other users or entities) in improving their performance and achieving their career or other goals with the assistance of external motivation.

It is difficult for organizations to develop IDPs, due to the people, processes and technologies within the organization. Documenting an individual's growth plan requires a wide range of tools, which may be utilized by each and every employer or other entity that the individual is associated with. The overall organizational strategic goal that is defined at the beginning of the year (or other defined time period) serves as an inspiration for the IDP. Strategic goals are measurable objectives that are indicative of an organization's long-term vision. They are the goals that an organization sets for itself. Therefore, the expectation of employers is for employees to improve their skills in accordance with the strategic goals. An IDP may include various components, including but not limited to: professional goals and aspirations; strengths and talents; development opportunities; and action plans.

Conversations with the managers and mentors of an employee (or other user or entity) may form the basis for a majority of that employee's IDP. It make take multiple rounds of conversation between an employee and a manager before they can agree on a plan. First, strategic goals need to be understood, and current employee skills need to be mapped. Conversations between and with the manager and the employee in one or more previous years (or other defined time periods) may help in developing the employee's IDP. However, if the manager changes, or if the employee has joined the organization recently there may be no previous conversations or IDPs to work off of, and the process becomes cumbersome because both parties need time to understand each other and help to create the IDP according to the strategic goals.

Companies and other organizations and entities of every variety are coming to the realization that in order to thrive in today's uncertain, complex and ambiguous environment, they need their employees (or other users or entities) to continually improve their skills and contribute to the organization. As a result, both managers and employees need access to innovative tools that will assist them in guiding and recommending required skills, and in generating and recommending IDPs learning from strategic goals, employee self-assessments, and employee assessments at the end of the year or other defined time period. Illustrative embodiments provide technical solutions for learning and recommending IDPs and actions required for developing skills or otherwise effecting the IDPs.

In some embodiments, the technical solutions described herein are used to learn the goals (e.g., annual goals) that an entity, organization, division or manager thereof sets. The technical solutions described herein may further be used to identify the skills which are expected for employees (or other users or entities) with different roles, and to compare the identified skills with end of the year (or other defined time period) assessments of the employees (or other users or entities) to recommend IDPs. The technical solutions described herein enable employees and managers to make decisions as quickly as possible by proactively recommending the comparative perspective of IDPs based on an organization's strategic goals. This will ensure that there are no or fewer surprises in the latter part of the year (or other defined time period).

The technical solutions described herein can advantageously utilize intelligent engines and automation capabilities to provide an Intuitive Systematic Individual Development Plan Engine (ISIDPE) tool so that machines can read and interpret the evaluations of individual users or other entities. The ISIDPE tool uses the intelligent and trained engine and automation capabilities to comprehend the context, roles, domains and intentions of different employees (or other users or entities). The ISIDPE tool is then able to sort learning activities, working tasks and opportunity areas according to the relative importance that each of these factors has in relation to an organization's overall strategic goals. The ISIDPE tool may be used to provide innovations for the next generation of employee or other user or entity engagement. The ISIDPE tool is not an intelligent employee evaluation engine with a general purpose. To the contrary, the ISIDPE tool may be used to provide intelligent employee evaluation engines that are specifically configured and learn from assessment. To accomplish this, context-specific entities pertaining to users are configured during the setup process. In some embodiments, such context-specific entities are connected to both user self-assessments and user year-end (or other defined time period) assessments, and thus facilitate accumulation of user expertise over the course of time.

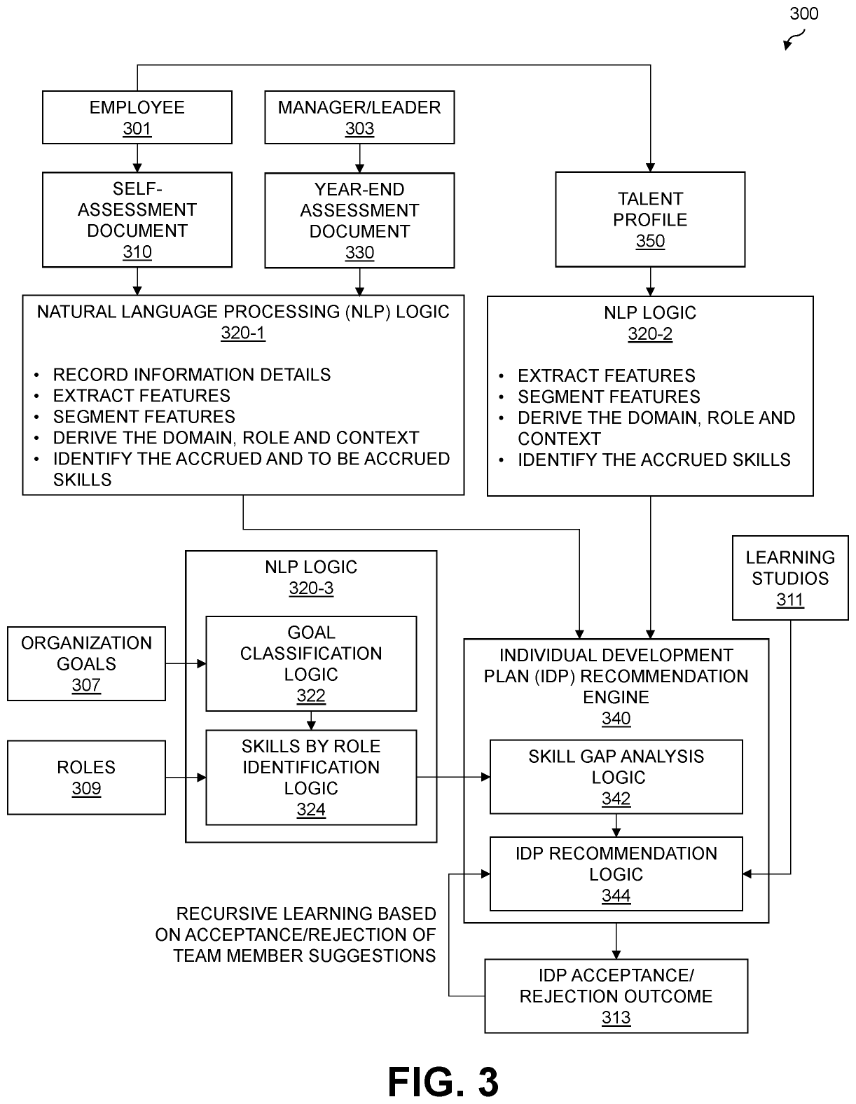

FIG. 3 depicts various activities of an ISIDPE tool 300 providing natural language processing (NLP) logic 320 as well as an IDP recommendation engine 340. The NLP logic 320 functionality shown in FIG. 3 is broken down into three parts, NLP logic 320-1, 320-2 and 320-3, which process different input and information that is fed to the IDP recommendation engine 340. The NLP logic 320-1 processes a self-assessment document 310 associated with an employee 301 (or another user or entity for which an IDP is to be generated/recommended) as well as a year-end (or other defined time period) assessment 330 provided by a manager/leader 303 of the employee 301. The NLP logic 320-1 records information details from the self-assessment document 310 and the year-end assessment document 330, extracts features therefrom, segments the features, derives the domain, role and context, and identifies the accrued and to be accrued skills for the employee 301. The NLP logic 320-2 processes a talent profile 350 of the employee 301, and similarly extracts features therefrom, segments the features, derives the domain, role and context, and identifies the accrued skills for the employee 301.

The NLP logic 320-3 processes one or more organization goals 307 and organization roles 309. The NLP logic 320-3 implements goal classification logic 322, which is configured to classify the organization goals 307, as well as skills by role identification logic 324 which identifies the skills which are needed for the different organization roles 309 of the organization, based at least in part on the classified organization goals 307. The output of the skills by role identification logic 324, as well as the output of the NLP logic 320-1 and 320-2, are provided to the IDP recommendation engine 340, which implements skill gap analysis logic 342 and IDP recommendation logic 344. The skill gap analysis logic 342 analyzes the accrued and to be accrued skills of the employee 301, as well as the output of the skills by role identification logic 324, to determine “skill gaps” of the employee 301 based on which of the organization roles 309 that the employee 301 fills. The determined skill gaps are then used by the IDP recommendation logic 344, along with input from one or more learning studios 311, to generate an IDP for the employee 301. The generated IDP is then accepted or rejected 313, with the result being used to implement recursive learning in the IDP recommendation logic 344 (e.g., based on acceptance or rejection of team member suggestions).

The NLP logic 320-1 and 320-2 have the capability to extract the self-assessment document 310 and the talent profile 350 associated with the employee 301, as well as the year-end assessment document 330 provided by a manager/leader 303 of the employee 301 in order to understand the accumulated and to-be-accumulated skills of the employee 301. The NLP logic 320-3 provides the capability to extract the organization goals 307 of an organization that the employee 301 belongs to or is associated with, as well as the organization roles 309 of the employee 301 within the organization. The goal classification logic 322 and skills by role identification logic 324 are configured to extract the organization's strategic goals in order to categorize and identify the skills that are expected by the organization roles 309 of the employee 301. The IDP recommendation engine 340 uses the skill gap analysis logic 342 to analyze the skills that have been accumulated by the employee 301 so far, and those that will (or should) be accumulated in the future, and compares such information with the skills that are driven by the organization goals 307. The IDP recommendation logic 344 uses such information to recommend an IDP for the employee 301 to acquire skills (e.g., through the integration of one or more learning studios 311). The employee 301 is also able to accept or reject the recommendations in the generated IDP, and uses feeds that have recursive learning in order to get better recommendations.

The ISIDPE tool 300 provides assessment intelligence via the NLP logic 320, which interprets language into specific vocabulary and takes into account misspellings, word synonyms, complicated abbreviations, etc. The NLP logic 320 may implement a natural language interpreter which identifies specified restrictions and grammar cloning, rule filtering, searching, grammar pruning, processing and restriction filtering. The NLP logic 320 may utilize a repository (not shown) which natively embraces relationships of text in assessment with skills and skill mappings with roles. The IDP recommendation engine 340 uses the skill gap analysis logic 342 to determine the skills of the employee 301 based on the classification of assessments (e.g., the self-assessment document 310, the year-end assessment document 330, the talent profile 350) and the current organization goals 307 and expected skills. The IDP recommendation engine 340 utilizes the IDP recommendation logic 344 to recommend an IDP and expected training sets based on feature details and segmented features with context and domain.

Creating an IDP may frequently be treated as a voluntary extra activity. Conventional approaches for creating IDPs may be based solely on conversations between employees and managers. The majority of the time, the manager and the employee will determine the skills as they go along. The individual is left to be responsible for improving their career-related, productivity-related and project-related skills. These competencies are not documented in any location. Rather, they are highlighted in the employee profile. The majority of the time, training requirements are gathered through communication, and employees are given the option to select their own training. The goals of the organization are frequently not taken into consideration when designing these trainings. It is very difficult to determine the training budget for the organization as a whole because the IDP is solely driven by the employee. As a result, money and other resources are not being spent appropriately, and employees are not receiving training that is relevant to the conversation. This results in skill gaps within the organization.

The technical solutions described herein provide a novel and original method for identifying and recommending skills to be developed for employees (or other users or entities), by training the ISIDPE tool 300 (e.g., the IDP recommendation engine 340 thereof) to make recommendations for employees based on their roles and how closely those roles align with an organization's strategic goals. In some embodiments, this is achieved by implementing a core component to build a skill repository or corpus, as well as assessment and goal processing as an expert system by learning, over time, employees and their role context within an organization. The IDP recommendation engine 340 recommend the IDPs for particular employees (e.g., employee 301), with the NLP logic 320 and other components of the ISIDPE tool 300 providing functionality for evaluating accumulated skills and required skills by determining context or role and utilizing a skill repository. The IDP recommendation may be supplemented with the competency-based training, and then it will be forwarded to the employee for approval or changes.

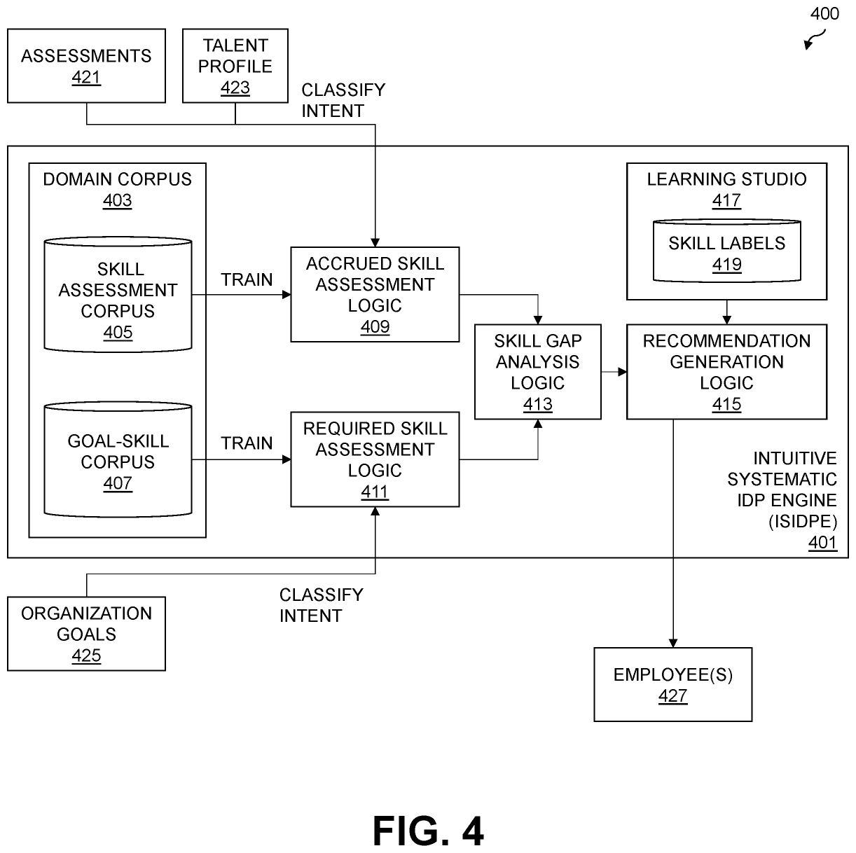

FIG. 4 shows a system 400 in which an ISIDPE engine 401 is implemented. The ISIDPE engine 401 comprises a domain corpus 403 implementing a skill assessment corpus 405 and a goal-skill corpus 407 which are used for training accrued skill assessment logic 409 and required skill assessment logic 411. The accrued skill assessment logic 409 and required skill assessment logic 411 implement an intent analyzer for skill classification. The accrued skill assessment logic 409 and the required skill assessment logic 411 are coupled with skill gap analysis logic 413, which is coupled with the recommendation generation logic 415. The recommendation generation logic 415 also takes as input skill labels 419 from a learning studio 417. The accrued skill assessment logic 409 is trained using the skill assessment corpus 405, and takes as input assessments 421 (e.g., employee or other user self-assessments, manager/leader assessments, etc.) as well as a talent profile 423 to classify intent and determine the accrued skills of particular employees or other users. The required skill assessment logic 411 is trained using the goal-skill corpus 407 and takes as input the organization's strategic goals 425 to classify intent and determine the required skills of particular employees or other users. The accrued and required skills are used by the skill gap analysis logic 413 to determine “skill gaps” (e.g., mismatches between the accrued and required skills for particular employees or other users based on their roles within an organization and that organization's strategic goals 425). The skill gaps are then used by the recommendation generation logic 415 to generate IDPs which are provided to employees 427 or other users. The ISIDPE engine 401 may implement interface layers (e.g., application programming interfaces (APIs)) that are accountable for reading the assessments 421, the talent profile 423 and the organization's strategic goals 425.

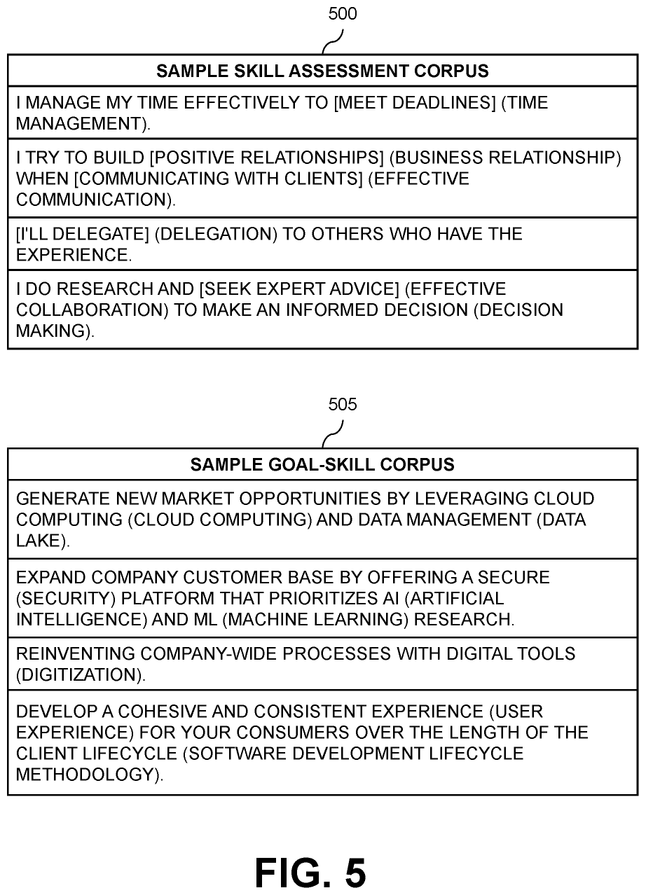

The ISIDPE engine 401 develops the skill assessment corpus 405 and the goal-skill corpus 407 for use in evaluation and strategic goal achievement. The skill assessment corpus 405 and the goal-skill corpus 407 may be used in conducting sentiment analysis. The domain corpus 403 may be organization-specific, and may differ from one organization to another. There may be similarities in the domain corpus 403 for different organizations if, for example, two organizations are engaged in comparable businesses or have similar ambitions. FIG. 5 shows a table 500 illustrating a portion of the skill assessment corpus 405, and a table 505 illustrating a portion of the goal-skill corpus 407.

A fundamental task in NLP and computational linguistics is sentiment analysis, also known as context-based opinion mining, to arrive at sentiment polarity. Target-dependent sentiment classification is typically regarded as a text classification problem. Sentiment analysis is crucial to understanding user-generated text (e.g., in assessment documents, forums, blogs, microblogs, research papers, etc.). Target-dependent sentiment classification is a fundamental task in sentiment analysis. In each sentence and for each target mention, the target-dependent sentiment classification is called to infer the sentiment polarity (e.g., positive, negative, neutral) of the sentence towards the target. Humans do not start their thinking from scratch every second—as one reads a document a user understands each word based on that user's understanding of previous words. The user will naturally “look at” parts of relevant context words, which are helpful to determine the sentiment polarity of a sentence towards the target. The user does not throw everything away and start thinking from scratch again as each new word is read-thoughts have persistence. In some embodiments, target-dependent sentiment classification is performed utilizing a Recurrent Neural Network (RNN) approach with Target Dependent Long Short-Term Memory (TD-LSTM) networks, which can learn continuous features (e.g., representations) without feature engineering while capturing the intricate relatedness among target, context and dependent words. TD-LSTM is a state-of-the-art performer for semantic composition in sentiment analysis.

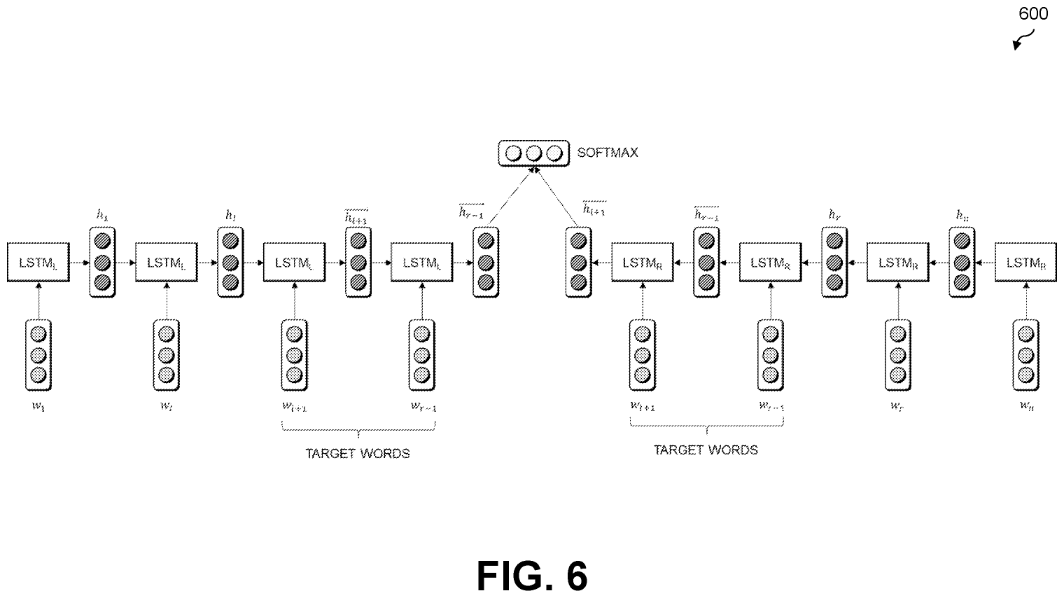

FIG. 6 shows an architecture 600 of a TD-LSTM network which may be used in some embodiments. The basic Long Short-Term Memory (LSTM) approach and its target-dependent extension TD-LSTM for target-dependent sentiment classification will now be described. w stands for a word in a sentence whose length is n, {wₗ₊₁, wₗ₊₂, . . . , wᵣ₋₁} are target words, {w₁, w₂, . . . wₗ} are preceding context words, and {wᵣ, . . . , wₙ₋₁, wₙ} are the following context words. The architecture 600 includes two LSTM networks, a “left” one LSTM_{L} and a “right” one LSTM_{R}, which are used to model the preceding contexts. The input of LSTM_{L} is the preceding contexts plus a target string, and the input of LSTM_{R} is the following contexts plus a target string. LSTM_{L} is run from left to right producing hidden vectors hₗ, \vec{hₗ₊₁}, \vec{hᵣ₋₁}, and LSTM_{R} is run from right to left producing hidden vectors hᵣ, [symbol] , [symbol] . This strategy is regarding the target string as the last unit, and can better utilize the semantics of the target string when using the composing representation for sentiment classification. Afterward, the last hidden vectors of LSTM_{L} and LSTM_{R} (\vec{hᵣ₋₁} and [symbol] ) are concatenated and fed to a softmax layer to classify the sentiment polarity label. In another approach, the last hidden vectors of LSTM_{L} and LSTM_{R} (\vec{hᵣ₋₁} and [symbol] ) are averaged or summed rather than concatenated.

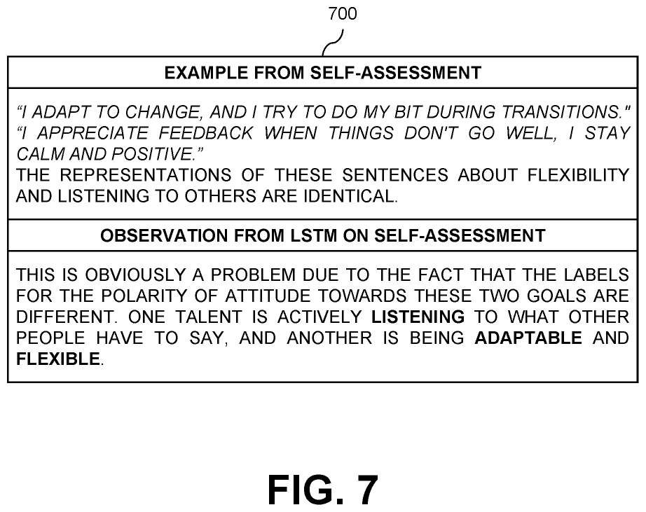

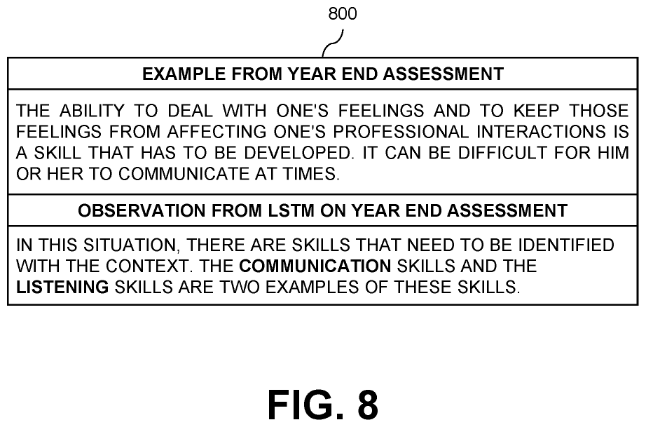

The TD-LSTM network may be trained end-to-end in a supervised learning framework. The loss function is a cross-entropy error of sentiment classification, which may be computed as:

$$loss = - {\sum }_{s ∈ S} {\sum }_{c = 1}^{C} {P}_{c}^{g} ( s ) \cdot log ( {P}_{c} ( s ) )$$

where S is the training data, C is the number of sentiment categories, s means a sentence, P_{c}(s) is the probability of predicting s as class c given by the softmax layer, and P_{c}^{g}(s) indicates whether class c is the correct sentiment category (e.g., where the value of P_{c}^{g}(s) is 1 or 0). The derivative of the loss function is taken through back-propagation with respect to all parameters and update parameters with Stochastic Gradient Descent (SGD). After determining the polarity of the sentiment, the next step is to analyze the risk factors posed by the text. The LSTM_{L} as well as the LSTM_{R} are able to distinguish the context words that occur before and after the present context word in order to correctly identify the skill. FIG. 7 shows a table 700 illustrating an example of content from a self-assessment document, along with the sentiment classification observation from the TD-LSTM network on the self-assessment. FIG. 8 shows a table 800 illustrating an example of content from a year-end assessment document, along with the sentiment classification observation from the TD-LSTM network on the year-end assessment.

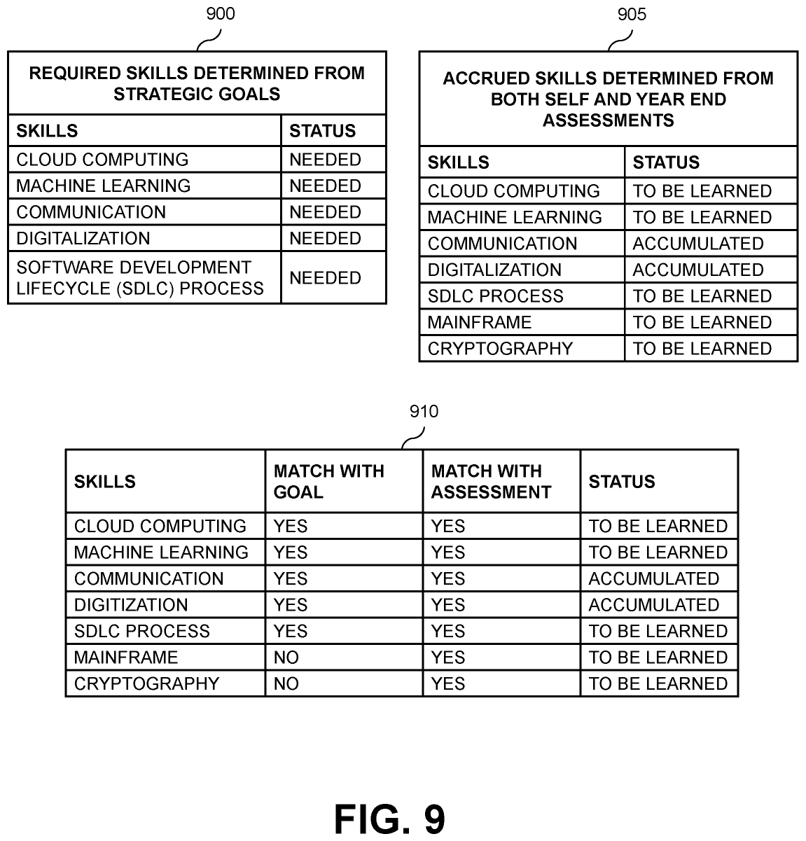

Skill gap analysis will now be described in further detail. The study of skill gaps is a component that intersects skills from strategic goals and assessments made both of oneself and at the end of the year or other defined time period. While assessment goals can either be accumulated or to be learned, strategic goals should be accomplished before moving on to the next step. The results of the sentiment analysis are used to categorize the intended goals. FIG. 9 shows a table 900 showing the required skills determined from strategic goals (e.g., the skills needed for a particular user in a particular role within an organization), and a table 905 of the accrued skills determined from assessment documents (e.g., self-assessments, year-end assessments, etc.). The required and accrued skills may be determined using the TD-LSTM network described above. The intersection of the required and accrued skills is illustrated in the table 910, which lists the skills and their matches with goals and assessments, providing a status of each (e.g., to be learned, accumulated, etc.). Skills that are marked “yes” in the match with goal column of the table 910 and have a status of “to be learned” in the status column of the table 910 are required skills for the IDP, whereas the skills that are marked “no” in the match with goal column of the table 910 and have a status of “to be learned” in the status column of the table 910 are optional skills for the IDP. The employee and their manager can review and approve the generated IDP.

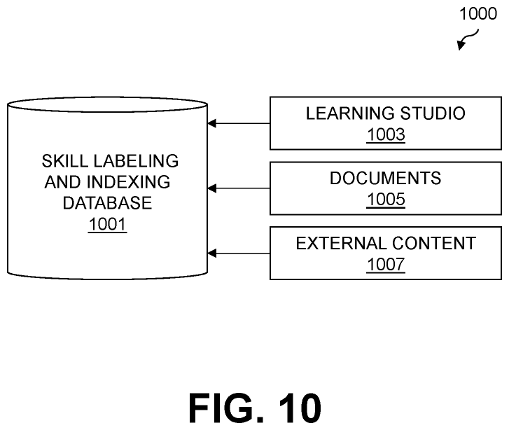

The skill gap analysis identifies the skills to be gained, as described above. Labeling and indexing the information may be used to map the generated IDP with courses (or other training or learning processes) that are offered by the user's organization or third-parties (e.g., via one or more learning studios) to learn the required and optional skills. The competencies will be linked to the content, and the process of indexing content may involve labelling or tagging individual pieces of data with certain features or descriptors. This enables the content to be easily searched for and retrieved at a later time. In some embodiments, a metadata indexing approach is used to identify the courses (or other training or learning processes) that a particular user should take based on that user's generated IDP. The metadata indexing allows for searching new content added to the repository, and keeps course ratings up-to-date as they may change over time. Course content key words can be added by an organization, and other indexing will be done in a systematic manner based on when new contents are added. FIG. 10 shows a repository 1000 including a skill labeling and indexing database 1001 which includes content that is added, labeled and indexed. The skill labeling and indexing database 1001 may be built using content from a learning studio 1003, documents 1005, and external content 1007.

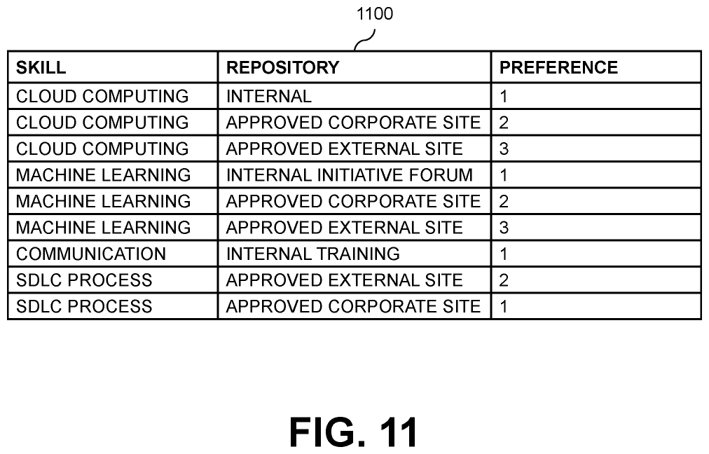

Consider, as an example, the skill of “cloud computing” which is associated with both cloud computing courses and papers in addition to the content that has been externally certified by the repository. A recommendation will be provided as a result of the information included in the repository. When making recommendations, the quality of the content also is taken into account and given a rating. FIG. 11 shows a table 1100 depicting a sample of a skill repository along with preferences information.

The technical solutions described herein provide an optimized machine learning framework that combines machine learning techniques with detailed implementation recommendations that, when combined with an organization's strategic goals and an employee's (or other user or entity's) assessment summary, allows for the automated generation of personalized IDPs for each employee (or other user or entity). The technical solutions can thus avoid the manual completion of significant decision-making processes that, if not automated using the technical solutions described herein, would require a significant amount of time and effort to complete. The technical solutions described herein advantageously allow IDPs to be generated and implemented in an automated and methodical manner, achieving significant time savings when developing the IDPs in line with overall aims or strategic goals of organizations. Training needs are accurately determined, and funding or other resources can be allotted to and utilized for the purposes of the organization. These innovations assist employees (or other users and entities) to accurately determine, improve and track productivity and career-related skills thereby having a positive impact on an organization's culture code.

In some embodiments, a method includes performing NLP of a first set of documents to generate a first data structure, the first set of documents characterizing information associated with a user of an organization, and performing NLP of a second set of documents to generate a second data structure, the second set of documents characterizing information associated with the organization. The method also includes processing the first data structure and the second data structure utilizing one or more machine learning models to generate a third data structure, the third data structure characterizing resources of an IT infrastructure to be allocated for use by the user of the organization. The method further includes generating one or more control signals for allocating one or more resources of the IT infrastructure for use by the user of the organization based at least in part on the third data structure. The method may be performed, for example, using the IDP generation system 110 utilizing one or more of the skills determination logic 112, the skill gap analysis logic 114 and the IDP generation logic 116.

It should be noted that the term “data structure” as used herein is intended to be broadly construed. A data structure, such as any single one of or combination of the first, second and third data structures referred to above, may provide a portion of a larger data structure, or any one of or combination of the first, second and third data structures may be combinations of multiple smaller data structures. Therefore, the first, second and third data structures referred to above may be different parts of a same overall data structure, or one or more of the first, second and third data structures could be made up of multiple smaller data structures. A data structure may comprise one or more tables or other arrangements of data.

The first set of documents may comprise one or more documents characterizing a set of accrued skills associated with the user of the organization. The one or more documents characterizing the set of accrued skills associated with the user of the organization may comprise at least one of a user self-assessment document, a periodic assessment document generated by a manager of the user in the organization, and a talent profile of the user. The NLP of the first set of documents may utilize target-dependent sentiment classification of content of the one or more documents characterizing the set of accrued skills associated with the user of the organization.

The second set of documents may comprise one or more documents characterizing a set of role-based skills associated with one or more roles that the user has within the organization. The set of role-based skills associated with the one or more roles that the user has within the organization may comprise at least one of: one or more career-related skills; one or more productivity-related skills; and one or more project-related skills associated with one or more projects that the user is performing for the organization.

The one or more machine learning models utilized to process the first data structure and the second data structure may comprise a RNN machine learning model. The RNN machine learning model may comprise one or more TD-LSTM networks.

The first data structure may specify a set of accrued skills associated with the user of the organization, the second data structure may specify a set of required skills associated with one or more roles that the user has within the organization, and the third data structure may comprise an IDP generated for the user. The IDP specifies one or more skills to be accrued by the user, the one or more skills to be accrued by the user being determined based at least in part on identifying one or more skill gaps between the set of accrued skills associated with the user of the organization and the set of required skills associated with the one or more roles that the user has within the organization. The one or more skills to be accrued by the user specified in the IDP may comprise a first set of one or more required skills and a second set of one or more optional skills. The first set of one or more required skills may be determined based at least in part on the one or more roles that the user has within the organization, and the second set of one or more optional skills may be determined based at least in part on one or more assessment documents associated with the user.

Allocating the one or more resources of the IT infrastructure for use by the user of the organization may comprise at least one of: conditioning selection of one or more courses for developing at least a given one of the one or more skills to be accrued by the user based at least in part on user preferences related to sources of the one or more courses; provisioning one or more workspaces for the user and assigning at least one of processing, memory, storage and network resources to the provisioned one or more workspaces based at least in part on the one or more skills to be accrued by the user as specified in the IDP; and provisioning one or more workspaces for the user and loading software in the provisioned one or more workspaces based at least in part on the one or more skills to be accrued by the user as specified in the IDP.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for generation of IDPs based on skill gaps identified between user-accrued skills and organization role-based skills will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100 in FIG. 1. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. A hypervisor platform may be used to implement a hypervisor within the virtualization infrastructure 1204, where the hypervisor platform has an associated virtual infrastructure management system. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1302-1 in the processing platform 1300 comprises a processor 1310 coupled to a memory 1312.

The processor 1310 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1312 may comprise random access memory (RAM), read-only memory (ROM), flash memory or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for generation of IDPs based on skill gaps identified between user-accrued skills and organization role-based skills as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, machine learning models, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to perform natural language processing of a first set of documents to generate a first data structure, the first set of documents characterizing information associated with a user of an organization;
to perform natural language processing of a second set of documents to generate a second data structure, the second set of documents characterizing information associated with the organization;
to process the first data structure and the second data structure utilizing one or more machine learning models to generate a third data structure, the third data structure characterizing resources of an information technology infrastructure to be allocated for use by the user of the organization; and
to generate one or more control signals for allocating one or more resources of the information technology infrastructure for use by the user of the organization based at least in part on the third data structure.

2. The apparatus of claim 1 wherein the first set of documents comprises one or more documents characterizing a set of accrued skills associated with the user of the organization.

3. The apparatus of claim 2 wherein the one or more documents characterizing the set of accrued skills associated with the user of the organization comprise at least one of a user self-assessment document, a periodic assessment document generated by a manager of the user in the organization, and a talent profile of the user.

4. The apparatus of claim 2 wherein the natural language processing of the first set of documents utilizes target-dependent sentiment classification of content of the one or more documents characterizing the set of accrued skills associated with the user of the organization.

5. The apparatus of claim 1 wherein the second set of documents comprises one or more documents characterizing a set of role-based skills associated with one or more roles that the user has within the organization.

6. The apparatus of claim 5 wherein the set of role-based skills associated with the one or more roles that the user has within the organization comprises at least one of:
one or more career-related skills;
one or more productivity-related skills; and
one or more project-related skills associated with one or more projects that the user is performing for the organization.

7. The apparatus of claim 1 wherein the one or more machine learning models utilized to process the first data structure and the second data structure comprise a recurrent neural network machine learning model.

8. The apparatus of claim 7 wherein the recurrent neural network machine learning model comprises one or more target dependent long short-term memory networks.

9. The apparatus of claim 1 wherein the first data structure specifies a set of accrued skills associated with the user of the organization, the second data structure specifies a set of required skills associated with one or more roles that the user has within the organization, and the third data structure comprises an individual development plan generated for the user, the individual development plan specifying one or more skills to be accrued by the user, the one or more skills to be accrued by the user being determined based at least in part on identifying one or more skill gaps between the set of accrued skills associated with the user of the organization and the set of required skills associated with the one or more roles that the user has within the organization.

10. The apparatus of claim 9 wherein the one or more skills to be accrued by the user specified in the individual development plan comprise a first set of one or more required skills and a second set of one or more optional skills.

11. The apparatus of claim 10 wherein the first set of one or more required skills is determined based at least in part on the one or more roles that the user has within the organization, and wherein the second set of one or more optional skills is determined based at least in part on one or more assessment documents associated with the user.

12. The apparatus of claim 9 wherein allocating the one or more resources of the information technology infrastructure for use by the user of the organization comprises conditioning selection of one or more courses for developing at least a given one of the one or more skills to be accrued by the user based at least in part on user preferences related to sources of the one or more courses.

13. The apparatus of claim 9 wherein allocating the one or more resources of the information technology infrastructure for use by the user of the organization comprises provisioning one or more workspaces for the user and assigning at least one of processing, memory, storage and network resources to the provisioned one or more workspaces based at least in part on the one or more skills to be accrued by the user as specified in the individual development plan.

14. The apparatus of claim 9 wherein allocating the one or more resources of the information technology infrastructure for use by the user of the organization comprises provisioning one or more workspaces for the user and loading software in the provisioned one or more workspaces based at least in part on the one or more skills to be accrued by the user as specified in the individual development plan.

15. A computer program product comprising a non-transitory processor-readable storage medium having stored therein program code of one or more software programs, wherein the program code when executed by at least one processing device causes the at least one processing device:
to perform natural language processing of a first set of documents to generate a first data structure, the first set of documents characterizing information associated with a user of an organization;
to perform natural language processing of a second set of documents to generate a second data structure, the second set of documents characterizing information associated with the organization;
to process the first data structure and the second data structure utilizing one or more machine learning models to generate a third data structure, the third data structure characterizing resources of an information technology infrastructure to be allocated for use by the user of the organization; and
to generate one or more control signals for allocating one or more resources of the information technology infrastructure for use by the user of the organization based at least in part on the third data structure.

16. The computer program product of claim 15 wherein the one or more machine learning models utilized to process the first data structure and the second data structure comprise a recurrent neural network machine learning model, and wherein the recurrent neural network machine learning model comprises one or more target dependent long short-term memory networks.

17. The computer program product of claim 15 wherein the first data structure specifies a set of accrued skills associated with the user of the organization, the second data structure specifies a set of required skills associated with one or more roles that the user has within the organization, and the third data structure comprises an individual development plan generated for the user, the individual development plan specifying one or more skills to be accrued by the user, the one or more skills to be accrued by the user being determined based at least in part on identifying one or more skill gaps between the set of accrued skills associated with the user of the organization and the set of required skills associated with the one or more roles that the user has within the organization.

18. A method comprising:
performing natural language processing of a first set of documents to generate a first data structure, the first set of documents characterizing information associated with a user of an organization;
performing natural language processing of a second set of documents to generate a second data structure, the second set of documents characterizing information associated with the organization;
processing the first data structure and the second data structure utilizing one or more machine learning models to generate a third data structure, the third data structure characterizing resources of an information technology infrastructure to be allocated for use by the user of the organization; and
generating one or more control signals for allocating one or more resources of the information technology infrastructure for use by the user of the organization based at least in part on the third data structure;
wherein the method is performed by at least one processing device comprising a processor coupled to a memory.

19. The method of claim 18 wherein the one or more machine learning models utilized to process the first data structure and the second data structure comprise a recurrent neural network machine learning model, and wherein the recurrent neural network machine learning model comprises one or more target dependent long short-term memory networks.

20. The method of claim 18 wherein the first data structure specifies a set of accrued skills associated with the user of the organization, the second data structure specifies a set of required skills associated with one or more roles that the user has within the organization, and the third data structure comprises an individual development plan generated for the user, the individual development plan specifying one or more skills to be accrued by the user, the one or more skills to be accrued by the user being determined based at least in part on identifying one or more skill gaps between the set of accrued skills associated with the user of the organization and the set of required skills associated with the one or more roles that the user has within the organization.
